(19) United States
(12) Patent Application Publication
(10) Pub. No.: US 2020/0050216 A1
(43) Pub. Date: Feb. 13, 2020

(54) CONTROL METHOD, APPARATUS, DEVICE, AND AIRCRAFT

(71) Applicant: SZ DJI TECHNOLOGY CO., LTD., Shenzhen (CN)

(72) Inventors: Canlong LIN, Shenzhen (CN); Li WANG, Shenzhen (CN)

(21) Appl. No.: 16/599,898

(22) Filed: Oct. 11, 2019

Related U.S. Application Data
(63) Continuation of application No. PCT/CN2017/085563, filed on May 23, 2017.

(51) Int. Cl. G05D 1/08; B64D 47/08; B64C 39/02; G03B 15/00

(52) U.S. Cl. CPC G05D 1/0816; B64D 47/08; B64C 2201/127; G03B 15/006; B64C 2201/14; B64C 39/024

(57) ABSTRACT

A control method includes obtaining an attitude limit angle of an aircraft, obtaining a current attitude angle of a gimbal mounted at the aircraft, and determining a flight attitude limit angle of the aircraft according to the attitude limit angle of the aircraft and the current attitude angle of the gimbal. The flight attitude limit angle is configured to constrain a tilt angle of the aircraft relative to a horizontal plane during flight, such that a vehicle body of the aircraft does not appear in an image captured by a photographing apparatus arranged at the gimbal.

### CROSS-REFERENCE TO RELATED APPLICATION

This application is a continuation of International Application No. PCT/CN2017/085563, filed on May 23, 2017, the entire content of which is incorporated herein by reference.

### TECHNICAL FIELD

The present disclosure relates to control technologies and, more particularly, to a control method, apparatus, device, and an aircraft.

### BACKGROUND

With the development of the computer technologies and the increasing demand of users, aircrafts, such as unmanned aerial vehicles (UAVs), are being used more and more widely. The aircraft generally includes a gimbal, a vehicle body, and a photographing apparatus for shooting images or videos. When the aircraft is shooting the images or videos, the gimbal is generally mounted below or above the aircraft, and the photographing apparatus carried by the gimbal observes and shoots the environment from different angles relative to the aircraft via a rotation of the gimbal. If the aircraft suddenly accelerates or urgently brakes, the vehicle body of the aircraft is caused to appear in the image shot by the photographing apparatus.

In conventional technologies, the shooting is generally controlled by changing a relative position between the mechanical structures of the aircraft, such as the UAV, to avoid the appearance of the vehicle body in the image. However, for an aircraft having a fixed structure, if a focal length of a lens of the photographing apparatus is adjusted, the problem of the appearance of the vehicle body in the image shot by the photographing apparatus within a rotation range of the gimbal is caused due to the change of the focal length.

### SUMMARY

In accordance with the disclosure, there is provided a control method including obtaining an attitude limit angle of an aircraft, obtaining a current attitude angle of a gimbal mounted at the aircraft, and determining a flight attitude limit angle of the aircraft according to the attitude limit angle of the aircraft and the current attitude angle of the gimbal. The flight attitude limit angle is configured to constrain a tilt angle of the aircraft relative to a horizontal plane during flight, such that a vehicle body of the aircraft does not appear in an image captured by a photographing apparatus arranged at the gimbal.

Also in accordance with the disclosure, there is provided a control method including obtaining a current attitude angle of an aircraft during flight, calculating a rotation angle of a gimbal mounted at the aircraft according to the current attitude angle of the aircraft, and controlling the gimbal to rotate according to the rotation angle of the gimbal. The rotation angle is an angle that, after the gimbal is rotated for the rotation angle, an image captured by a photographing apparatus arranged at the gimbal does not include a vehicle body of the aircraft.

Also in accordance with the disclosure, there is provided a control device including a memory storing program instructions and a processor. The processor is configured to execute the program instructions to obtain an attitude limit angle of an aircraft, obtain a current attitude angle of a gimbal mounted at the aircraft, and determine a flight attitude limit angle of the aircraft according to the attitude limit angle of the aircraft and the current attitude angle of the gimbal. The flight attitude limit angle is configured to constrain a tilt angle of the aircraft relative to a horizontal plane during flight, such that a vehicle body of the aircraft does not appear in an image captured by a photographing apparatus arranged at the gimbal.

Also in accordance with the disclosure, there is provided an unmanned aerial vehicle (UAV) including a vehicle body, a power system arranged at the vehicle body, and a flight controller. The power system is configured to provide a flight power to the UAV. The flight controller is configured to obtain an attitude limit angle of an aircraft, obtain a current attitude angle of a gimbal mounted at the aircraft, and determine a flight attitude limit angle of the aircraft according to the attitude limit angle of the aircraft and the current attitude angle of the gimbal. The flight attitude limit angle is configured to constrain a tilt angle of the aircraft relative to a horizontal plane during flight, such that a vehicle body of the aircraft does not appear in an image captured by a photographing apparatus arranged at the gimbal.

### BRIEF DESCRIPTION OF THE DRAWINGS

FIG. 1 is a schematic front view showing an aircraft according to embodiments of the disclosure.

FIG. 2 is a schematic side view showing an aircraft according to embodiments of the disclosure.

FIG. 3 is a schematic side view showing an aircraft being in a flying state according to embodiments of the disclosure.

FIG. 4 is a schematic side view showing an aircraft when a gimbal tilts downward according to embodiments of the disclosure.

FIG. 5 is a schematic side view showing an aircraft when a gimbal tilts upward according to embodiments of the disclosure.

FIG. 6 is a schematic flowchart of a control method according to embodiments of the disclosure.

FIG. 7 is a schematic flowchart of another control method according to embodiments of the disclosure.

FIG. 8 is a schematic flowchart of another control method according to embodiments of the disclosure.

FIG. 9 is a schematic structural diagram of a control apparatus according to embodiments of the disclosure.

FIG. 10 is a schematic structural diagram of another control apparatus according to embodiments of the disclosure.

FIG. 11 is a schematic structural diagram of a control device according to embodiments of the disclosure.

FIG. 12 is a schematic structural diagram of another control device according to embodiments of the disclosure.

### DETAILED DESCRIPTION OF THE EMBODIMENTS

A control method consistent with the disclosure can be implemented by a control device. The control device can be arranged at an aircraft. In some embodiments, the control device can be also arranged at a smart device. The processing manner of the control method is similar or same whether the control device is arranged at the aircraft or at the smart device. Hereinafter, takes the control device arranging at the aircraft as an example to describe the embodiments of the discourse.

Generally, when the aircraft is flying, a sudden acceleration, an emergency braking, or the like, may cause a problem that an image captured by a photographing apparatus carried by a gimbal may include a portion of a vehicle body of the aircraft. When the gimbal rotates in a roll direction with a pitch angle unchanged, a view angle of the photographing apparatus always has a conical shape and a distance between an upper boundary of the view angel and a bottom edge of the vehicle body can remain unchanged. Therefore, only a rotation in a pitch direction of the gimbal may need to be considered regarding the problem that the image captured by the photographing apparatus may include a portion of the vehicle body of the aircraft.

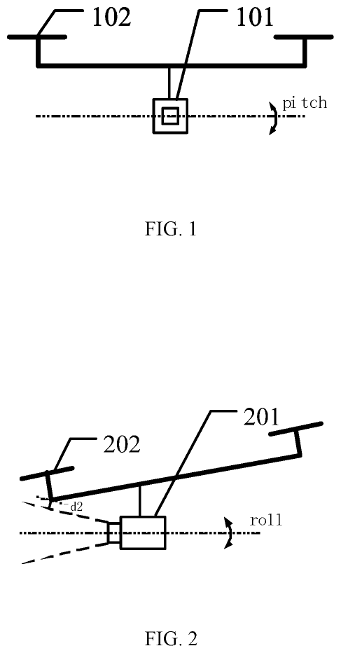

FIG. 1 is a schematic front view showing a structure of an aircraft consistent with the disclosure. As shown in FIG. 1, a gimbal 101 is arranged below a vehicle body 102 and can rotate in the pitch direction. FIG. 2 is a schematic side view showing an aircraft consistent with the disclosure. As shown in FIG. 2, a gimbal 201 is arranged below a vehicle body 202. A closest distance d2 between the upper boundary of the view angle and the vehicle body 202 of the aircraft refers to a distance between the upper boundary of the view angle and the vehicle body 202 of the aircraft when the aircraft is tilting at a maximum tilt angle. The tilt angle refers to an angle of the aircraft relative to the horizontal plane during flight. As shown in FIG. 2, when the gimbal 201 rotates in the roll direction, the view angle of the photographing apparatus carried by the gimbal 201 has the conical shape, and the closest distance d2 remains unchanged, such that an attitude angle of the vehicle body does not need to be constrained.

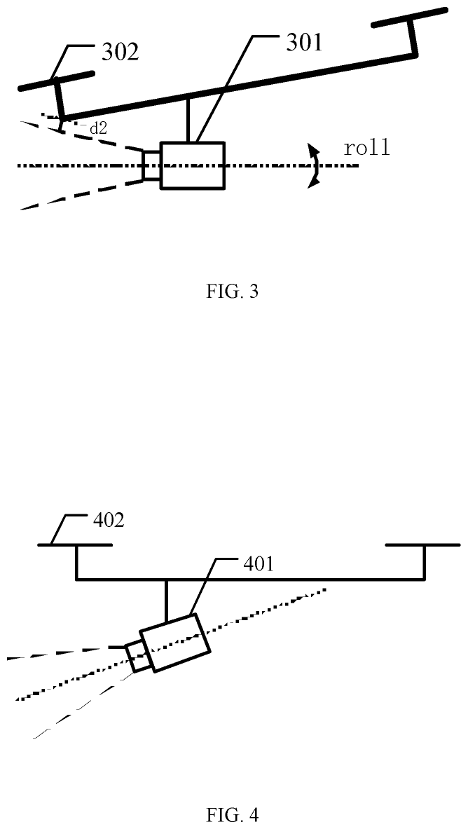

Hereinafter, a movement of the aircraft in the pitch direction will be analyzed. FIG. 3 is a schematic side view showing an aircraft being in a flying state consistent with the disclosure. As shown in FIG. 3, if an attitude angle of the aircraft during a forward flight and during braking can be controlled within a specified range, a distance d2 between the upper boundary of the view angle of the photographing apparatus carried by a gimbal 301 and the bottom edge of the vehicle body 302 of the aircraft can be greater than zero, and the image captured by the photographing apparatus will not include the vehicle body 320. Regarding to a braking control effectiveness, the tilt angle of the aircraft during braking may exceed a horizontal plane corresponding to the gimbal 301, thereby causing the distance d2 to be smaller than zero. As such, the image captured by the camera apparatus will include the vehicle body 320. Therefore, the attitude angle of the aircraft can be further limited to avoid the problem described above. For example, a compensation angle can be introduced to buffer an overshoot of a braking control.

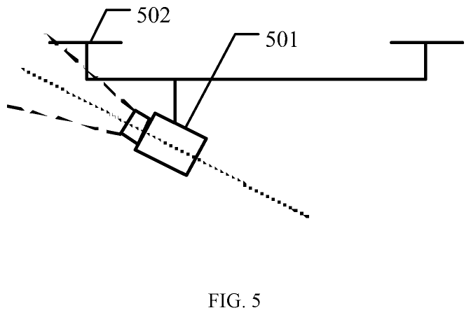

If the aircraft is flying backward or performing a backward brake, the attitude angle of the aircraft does not need to be limited and can be determined by a corresponding flight mode. FIG. 4 is a schematic side view showing an aircraft when a gimbal 401 is tilting downward consistent with the disclosure. As shown in FIG. 4, if the view angle of the gimbal 401 is tilting downward (e.g., the pitch angle of the gimbal 401 is greater than zero, or a specific definition of the view angle tilting downward can be determined by the gimbal 401), the attitude of the aircraft does not need to be limited based on the spatial geometry knowledge. FIG. 5 is a schematic side view showing an aircraft when a gimbal 501 is tilting upward consistent with the disclosure. The gimbal 501 being tilting upward can include, for example, the pitch angle of the gimbal 501 is smaller than zero, and can be controlled by the user. As shown in FIG. 5, if the pitch angle of the gimbal 501 is greater than a certain angle, a portion of the vehicle body 502 may appear in the image even if the aircraft is hovering. Therefore, in order to minimize an area of the vehicle body 502 appeared in the image captured by the photographing apparatus, the attitude angle of the aircraft that has already been limited according to the requirement of the gimbal can be further limited by, for example, 5 degrees.

In some embodiments, a flight mode can be selected. First, the aircraft can fly without carrying the gimbal, and the control device can obtain a first attitude limit angle of the aircraft. The first attitude limit angle refers to a maximum tilt angle of the aircraft in the current flight mode. In the current flight mode, the aircraft can then fly with the gimbal mounted at the aircraft, and the control device can obtain a current attitude angle of the gimbal. The attitude angle of the gimbal refers to a current tilt angel of the gimbal. The control device can calculate a flight attitude limit angle of the aircraft according to the obtained first attitude limit angle of the aircraft and the current attitude angle of the gimbal. The flight attitude limit angle can be configured to limit the tilt angle of the aircraft relative to the horizontal plane during flight, such that the vehicle body of the aircraft cannot appear in the image captured by the photographing apparatus carried by the gimbal with the restriction of the flight attitude limit angle.

Three-axis Euler angles of the aircraft in the current flight mode can be obtained. The three-axis Euler angles can include the pitch angle, a roll angle, and a yaw angle. The control device can estimate the flight attitude limit angle of the aircraft in real time according to the obtained three-axis Euler angles. The flight attitude limit angle can be configured to limit the tilt angle of the aircraft relative to the horizontal plane during flight. The vehicle body of the aircraft would not appear in the image captured by the photographing apparatus carried by the gimbal with the restriction of the flight attitude limit angle. The control device can estimate the flight attitude limit angle of the aircraft in real time, according to the obtained three-axis Euler angles, using the conventional conversion methods.

In some embodiments, three-axis Euler angles of the gimbal can be obtained. The three-axis Euler angles of the gimbal can include a pitch angel, a roll angle, and a yaw angle of the gimbal. The control device can convert the three-axis Euler angles to a Direction Cosine Matrix (DCM) according to a formula for converting the three-axis Euler angles to the DCM. The DCM can be converted to the tilt angle of the gimbal. The tilt angle of the gimbal refers to an angle between a coordinate system of the gimbal and a coordinate system of the vehicle body of the aircraft, and can determine whether the vehicle body is included in the image captured by the photographing apparatus. The tilt angle being greater than zero indicates that the view angle of the gimbal is tilting downward with respect to the horizontal, and the tilt angle being smaller than zero indicates that the view angle of the gimbal is tilting upward with respect to the horizontal. When the view angle of the gimbal is horizontal and the aircraft is flying in the current flight mode, a second attitude limit angle of the aircraft can be obtained. The second attitude limit angle can be obtained by subtracting a preset compensation angle from a preset initial attitude angle. The initial attitude angle refers to the tilt angle of the aircraft during flight, when the vehicle body of the aircraft is not included in the image captured by the photographing apparatus carried by the gimbal. The control device can determine the flight attitude limit angle of the aircraft according to the first attitude limit angle B of the aircraft, the tilt angle of the gimbal (tilt), the second attitude limit angle A of the aircraft, and the preset attitude limit angle range [M, N], based on a preset formula min{B, A+constrain(tilt, −M, +N)}. Min{X, Y} refers to obtaining a smaller value of X and Y, and constrain(tilt, −M, +N) refers to limit a tilt range of the aircraft to [−M, +N]. Therefore, the maximum yaw angle of the aircraft can be controlled not to exceed the flight attitude limit angle, such that the image captured by the photographing apparatus of the aircraft does not include the vehicle body of the aircraft.

For example, the first attitude limit angle B of the aircraft in the current flight mode obtained by the control device is 40 degrees. When the gimbal is not mounted at the aircraft, the first attitude limit angle B of the aircraft in the current flight mode can be maintained at 40 degrees. When the aircraft is carrying the gimbal, if the gimbal is parallel to the horizontal plane, the second attitude limit angle A of the aircraft can be measured to be, for example, 30 degrees. As an example, the view angle of the gimbal is tilting downward with respect to the horizontal plane, i.e., tilt >0. Assume tilt is 20 degrees and M and N in the preset attitude limit angle range are M=5°, N=45°, respectively, the flight attitude limit angle of the aircraft can be calculated as min{B, A+constrain(tilt, −M, +N)}=min{40, 30+20}=40, which is same as the first attitude limit angle B. Therefore, the image captured by the photographing apparatus would not include the vehicle body of the aircraft.

As another example, the first attitude limit angle B of the aircraft in the current flight mode obtained by the control device is 40 degrees. When the gimbal is not mounted at the aircraft, the first attitude limit angle B of the aircraft in the current flight mode can be maintained at 40 degrees. When the aircraft is carrying the gimbal, if the gimbal is parallel to the horizontal plane, the second attitude limit angle A of the aircraft can be measured to be, for example, 30 degrees. As an example, the view angle of the gimbal is tilting upward with respect to the horizontal plane, i.e., tilt <0. Assume tilt is −10 degrees and M and N in the preset attitude limit angle range are M=5°, N=45°, respectively, the flight attitude limit angle of the aircraft can be calculated as min{B, A+constrain(tilt, −M, +N)}=min{40, 30−5}=25. The flight attitude limit angle B of the aircraft can be changed from 40 degrees to 25 degrees, such that the image captured by the photographing apparatus would not include the vehicle body of the aircraft.

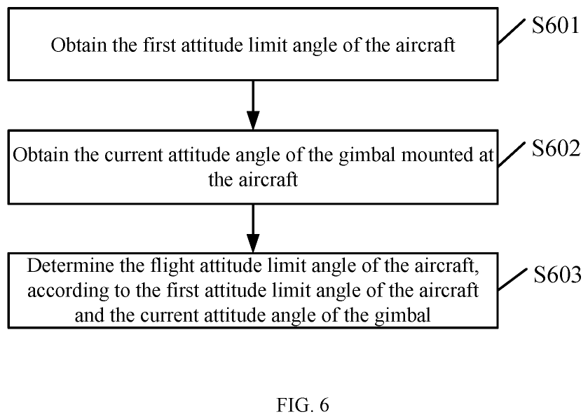

FIG. 6 is a schematic flowchart of a control method consistent with the disclosure. The control method can be implemented by the control device. As shown in FIG. 6, at S601, the first attitude limit angle of the aircraft is obtained.

In some embodiments, the control device can obtain the first attitude limit angle of the aircraft. The flight mode can include one of a plurality of movement modes or the like, and the first attitude limit angle can be set for each movement mode according to the requirements. For example, the aircraft can fly without carrying the gimbal, according to the current flight mode selected by the user. The control device can obtain the first attitude limit angle of the aircraft according to the current flight mode of the aircraft. The first attitude limit angle refers to the maximum tilt angle of the aircraft in the current flight mode. For example, when the aircraft does not carry the gimbal, the control device can obtain the first attitude limit angle B of the aircraft in the current flight mode to be, e.g., 40 degrees.

At S602, the current attitude angle of the gimbal mounted at the aircraft is obtained.

In some embodiments, the control device on the aircraft can obtain the current attitude angle of the gimbal mounted at the aircraft. For example, when the aircraft carrying the gimbal is flying in the current flight mode, and the control device can obtain the current attitude angle of the gimbal. The current attitude angle of the gimbal can include the three-axis Euler angles. The three-axis Euler angles can include the pitch angle, the roll angle, and the yaw angle of the gimbal. For example, when the aircraft carrying the gimbal is flying in the current flight mode, and the control device can obtain the current attitude angle of the gimbal, e.g., the pitch angle is 40 degrees, the roll angle is 10 degrees, and the yaw angle is 20 degrees.

At S603, the flight attitude limit angle of the aircraft is determined according to the first attitude limit angle of the aircraft and the current attitude angle of the gimbal.

In some embodiments, the control device can determine the flight attitude limit angle of the aircraft according to the first attitude limit angle of the aircraft and the current attitude angle of the gimbal. For example, when the aircraft is flying, the control device can obtain the first attitude limit angle of the aircraft and the current attitude angle of the gimbal. The control device can calculate the tilt angle of the gimbal using the preset calculation formula according to the current attitude angle of the gimbal. The tilt angle of the gimbal refers to the angle between the coordinate system of the gimbal and the coordinate system of the vehicle body of the aircraft. The control device can calculate and determine the flight attitude limit angle of the aircraft using the preset formula, according to the obtained first attitude limit angle, the tilt angle of the gimbal, the second attitude limit angle, and the preset attitude limit angle range. The preset attitude limit angle range can include a first preset attitude limit angle of the gimbal corresponding to the gimbal rotating toward the aircraft, and a second preset attitude limit angle of the aircraft corresponding to the gimbal rotating away from the aircraft. For example, when the aircraft is flying, the first attitude limit angle B of the aircraft obtained by the control device is 40 degrees. According to the current attitude angle of the gimbal, the control device can calculate the tilt angle of the gimbal to be 20 degrees using the preset calculation formula. According to the obtained first attitude limit angle B, the tilt angle tilt of the gimbal, the second attitude limit angle A, and the preset attitude limit angle range [M, N] (e.g., M=5 degrees, N=45 degrees), and using the preset formula min{B, A+constrain(tilt, −M, +N)}, the control device can calculate the flight attitude limit angle of the aircraft as min{{B, A+constrain(tilt, −M, +N)}=min{40, 30+20}=40. Therefore, the control device can determine that the flight attitude limit angle of the aircraft is 40 degrees.

Therefore, through obtaining the first attitude limit angle of the aircraft and the current attitude angle of the gimbal, the flight attitude limit angle of the aircraft during flight can be determined. The maximum tilt angle of the aircraft can be controlled not to exceed the flight attitude limit angle, under the constrain of the flight attitude limit angle. As such, the problem of the appearance of the vehicle body of the aircraft in the image captured by the photographing apparatus at the gimbal can be solved, and an effectiveness of the photographing can be improved.

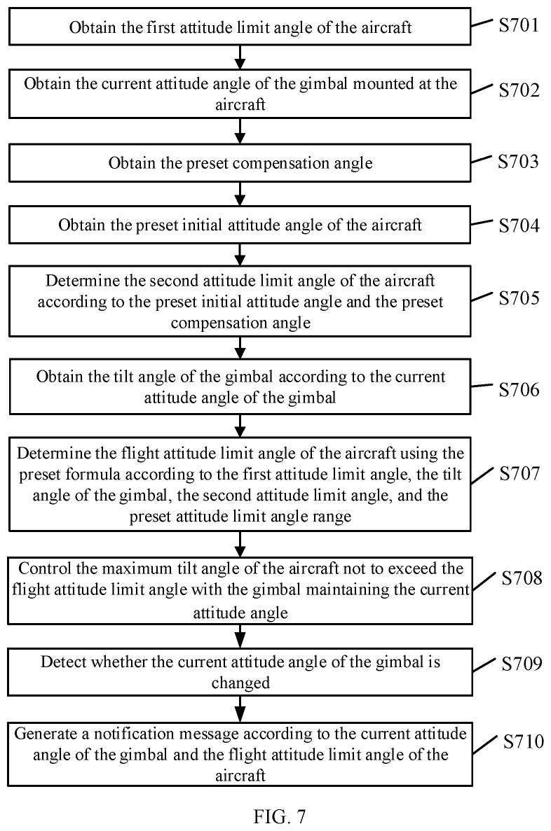

FIG. 7 is a schematic flowchart of the control method consistent with the disclosure. The control method can be implemented by the control device. As shown in FIG. 7, at S701, the first attitude limit angle of the aircraft is obtained.

In some embodiments, the control device can obtain the first attitude limit angle of the aircraft. For example, the aircraft can fly without carrying the gimbal according to the current flight mode selected by the user. The control device can obtain the first attitude limit angle of the aircraft according to the current flight mode of the aircraft. The first attitude limit angle refers to the maximum tilt angle of the aircraft in the current flight mode. For example, when the aircraft does not carry the gimbal, the control device can obtain the first attitude limit angle B of the aircraft in the current flight mode to be e.g., 40 degrees.

At S702, the current attitude angle of the gimbal mounted at the aircraft is obtained.

In some embodiments, the control device on the aircraft can obtain the current attitude angle of the gimbal mounted at the aircraft. For example, when the aircraft carrying the gimbal is flying in the current flight mode, and the control device can obtain the current attitude angle of the gimbal. The current attitude angle of the gimbal can include the three-axis Euler angles. The three-axis Euler angles can include the pitch angle, the roll angle, and the yaw angle of the gimbal. For example, when the aircraft carrying the gimbal is flying in the current flight mode, and the control device can obtain the current attitude angle of the gimbal, e.g., the pitch angle is 40 degrees, the roll angle is 10 degrees, and the yaw angle is 20 degrees.

At 703, the preset compensation angle is obtained.

In some embodiments, the control device can obtain the preset compensation angle. For example, if the user sets the compensation angle of the aircraft as 5 degrees, the control device can obtain the compensation angle preset by the user.

At S704, the preset initial attitude angle of the aircraft is obtained.

In some embodiments, the control method can obtain the preset initial attitude angle of the aircraft. For example, the user can obtain the tilt angle of the aircraft at which the image captured by the photographing apparatus mounted on the gimbal does not include the vehicle body of the aircraft. The control device can obtain the tilt angle of the aircraft as the preset initial attitude angle of the aircraft.

At S705, the second attitude limit angle of the aircraft is determined, according to the preset initial attitude angle and the preset compensation angle.

In some embodiments, the control device can determine the second attitude limit angle of the aircraft according to the preset initial attitude angle and the preset compensation angle. For example, when the aircraft is flying, the control device can obtain the preset initial attitude angle of the aircraft and the preset compensation angle, and can subtract the preset compensation angle from the preset initial attitude angle to obtain the second attitude limit angle of the aircraft. For example, when the aircraft is flying, the preset initial attitude angle of the aircraft obtained by the control device is 35 degrees, and the obtained preset compensation angle of the aircraft is 5 degrees. The preset initial attitude angle of 35 degrees minus the preset compensation angle of 5 degrees is the second attitude limit angle of the aircraft of 30 degrees.

At S706, the tilt angle of the gimbal is obtained according to the current attitude angle of the gimbal.

In some embodiments, the control device can obtain the tilt angle of the gimbal according to the current attitude angle of the gimbal. For example, when the aircraft is flying, the control device can obtain the current attitude angle of the gimbal mounted at the aircraft. The attitude angle can include the three-axis Euler angles, e.g., the pitch angle, the roll angle, and the yaw angle. The control device can calculate the tilt angle of the gimbal according to the current attitude angle of the gimbal. The tilt angle of the gimbal refers to the angle between the coordinate system of the gimbal and the coordinate system of the vehicle body of the aircraft.

In some embodiments, the control device can convert the three-axis Euler angles to the DCM according to the formula for converting the three-axis Euler angles to the DCM. The DCM can be converted to the tilt angle of the gimbal. For example, assume that the obtained three-axis Euler angles of the gimbal are:

$$[ \begin{matrix}pitch \\ roll \\ yaw\end{matrix} ] = [ \begin{matrix}θ \\ ϕ \\ ψ\end{matrix} ]$$

A rotation matrix having three rows and three columns (3×3) can be obtained as follows:

$$[ \begin{matrix}1 & 0 & 0 \\ 0 & cos ( ϕ ) & sin ( ϕ ) \\ 0 & - sin ( ϕ ) & cos ( ϕ )\end{matrix} ] [ \begin{matrix}cos ( θ ) & 0 & - sin ( θ ) \\ 0 & 1 & 0 \\ sin ( θ ) & 0 & cos ( θ )\end{matrix} ] [ \begin{matrix}cos ( ψ ) & sin ( ψ ) & 0 \\ - sin ( ψ ) & cos ( ψ ) & 0 \\ 0 & 0 & 1\end{matrix} ] = [ \begin{matrix}cos ( θ ) ⋆ cos ( ψ ) & cos ( θ ) ⋆ sin ( ψ ) & - sin ( θ ) \\ sin ( ψ ) ⋆ sin ( θ ) ⋆ cos ( ψ ) - cos ( ϕ ) ⋆ sin ( ψ ) & sin ( ϕ ) ⋆ sin ( θ ) ⋆ sin ( ψ ) + cos ( ϕ ) ⋆ cos ( ψ ) & sin ( ϕ ) ⋆ cos ( θ ) \\ cos ( ϕ ) ⋆ sin ( θ ) ⋆ cos ( ψ ) + sin ( ϕ ) ⋆ sin ( ψ ) & cos ( ϕ ) ⋆ sin ( θ ) ⋆ sin ( ψ ) - sin ( ϕ ) ⋆ cos ( ψ ) & cos ( ϕ ) ⋆ cos ( θ )\end{matrix} ]$$

According to the mathematical definition, DCM is a transposed matrix of the rotation matrix. Therefore, the DCM can be as follows:

$$[ \begin{matrix}{dcm}_{00} & {dcm}_{01} & {dcm}_{02} \\ {dcm}_{10} & {dcm}_{11} & {dcm}_{12} \\ {dcm}_{20} & {dcm}_{21} & {dcm}_{22}\end{matrix} ] = [ \begin{matrix}cos ( θ ) ⋆ cos ( ψ ) & sin ( ϕ ) ⋆ sin ( θ ) ⋆ cos ( ψ ) - cos ( ϕ ) ⋆ sin ( ψ ) & cos ( ϕ ) ⋆ sin ( θ ) ⋆ cos ( ψ ) + sin ( ϕ ) ⋆ sin ( ψ ) \\ cos ( θ ) ⋆ sin ( ψ ) & sin ( ϕ ) ⋆ sin ( θ ) ⋆ sin ( ψ ) + cos ( ϕ ) ⋆ cos ( ψ ) & cos ( ϕ ) ⋆ sin ( θ ) ⋆ sin ( ψ ) - sin ( ϕ ) ⋆ cos ( ψ ) \\ - sin ( θ ) & sin ( ϕ ) ⋆ cos ( θ ) & cos ( ϕ ) ⋆ cos ( θ )\end{matrix} ]$$

The method of converting the DCM to the tilt angle of the gimbal can be as follows.

Define a coordinate system vector a of the gimbal as:

$$a = [ \begin{matrix}{dcm}_{20} \\ {dcm}_{21} \\ {dcm}_{22}\end{matrix} ] = [ \begin{matrix}- sin ( θ ) \\ sin ( ϕ ) ⋆ cos ( θ ) \\ cos ( ϕ ) ⋆ cos ( θ )\end{matrix} ]$$

Define a reference unit vector b of the vehicle body as:

$$b = [ \begin{matrix}0 \\ 0 \\ 1\end{matrix} ]$$

The angle between the two three-dimensional vectors <a, b> can be calculated according to the defined coordinate system vector a of the gimbal and the reference unit vector b of the vehicle body. The two vectors a and b need to be normalized, e.g., unitization with a modulus length being equal to 1. A sine value of the angle of the normalized vectors a and b can be first calculated. The sine value of the angle can be directly obtained by calculating a cross product of the unit vectors a and b, e.g., sine=a×b=|a| |b| sin(phi)=sin(phi). A cosine vale of the angle of the normalized vectors a and b can be then calculated. The cosine vale of the angle can be directly obtained by calculating a point multiplication of the unit vectors a and b, e.g., cosine=a·b=|a|×|b|×cos(delta)=cos(delta). Thus, an angle theta of the normalized two vectors a and b can be obtained. theta=a tan(sine, cosine), where a tan is an inverse tangent trigonometric function, and the calculated theta can be the tilt angle.

It can be appreciated that the method for the control device converting the current three-axis Euler angles of the gimbal into the DCM formula is not limited herein. Other methods can also be used for converting the current three-axis Euler angles of the gimbal into the tilt angle of the gimbal, which is not limited herein.

At S707, according to the first attitude limit angle, the tilt angle of the gimbal, the second attitude limit angle, and the preset attitude limit angle range, the flight attitude limit angle of the aircraft is determined using the preset formula.

In some embodiments, the control device can determine the flight attitude limit angle of the aircraft using the preset formula according to the first attitude limit angle, the tilt angle of the gimbal, the second attitude limit angle, and the preset attitude limit angle range. For example, when the aircraft is flying, the control device can obtain the first attitude limit angle of the aircraft and the current attitude angle of the gimbal. The control device can calculate the tilt angle of the gimbal using the preset calculation formula, according to the current attitude angle of the gimbal. The tilt angle of the gimbal refers to the angle between the coordinate system of the gimbal and the coordinate system of the vehicle body of the aircraft. According to the obtained first attitude limit angle, the tilt angle of the gimbal, the second attitude limit angle, and the preset attitude limit angle range, the control device can calculate and determine the flight attitude limit angle of the aircraft using the preset formula. The preset attitude limit angle range can include the first preset attitude limit angle of the gimbal corresponding to the gimbal rotating toward the aircraft, and the second preset attitude limit angle of the aircraft corresponding to the gimbal rotating away from the aircraft. For example, when the aircraft is flying, the first attitude limit angle B of the aircraft in the current flight mode obtained by the control device is 40 degrees. According to the current attitude angle of the gimbal, the control device can calculate the tilt angle of the gimbal to be 20 degrees using the preset calculation formula. According to the obtained first attitude limit angle B, the tilt angle tilt of the gimbal, the second attitude limit angle A, and the preset attitude limit angle range [M, N] (e.g., M=5 degrees, N=45 degrees), and using the preset formula min{B, A+constrain(tilt, −M, +N)}, the control device can calculate the flight attitude limit angle of the aircraft as min{{B, A+constrain(tilt, −M, +N)}=min{40, 30+20}=40. Therefore, the control device can determine that the flight attitude limit angle of the aircraft is 40 degrees.

At S708, with the gimbal maintaining the current attitude angle, the maximum tilt angle of the aircraft is controlled not to exceed the flight attitude limit angle.

In some embodiments, the control device can control the maximum tilt angle of the aircraft to not exceed the flight attitude limit angle with the gimbal maintaining the current attitude angle. For example, according to the calculated flight attitude limit angle, with the gimbal maintaining the current attitude angle, the control device can control the maximum tilt angle of the aircraft to not exceed the flight attitude limit angle, thereby avoiding the vehicle body to be appeared in the image captured by the photographing apparatus mounted at the gimbal. For example, if the flight attitude limit angle calculated by the control device is 40 degrees, with the gimbal maintaining the current attitude angle, the maximum tilt angle of the aircraft can be controlled to not exceed 40 degrees.

At S709, whether the current attitude angle of the gimbal is changed is detected.

In some embodiments, the control device can detect in real time whether the current attitude angle of the gimbal is changed, when the aircraft is in the current flight mode. If the current attitude angle of the gimbal is detected to be changed, the control device can be triggered to perform the process at S701.

At S710, a notification message is generated according to the current attitude angle of the gimbal and the flight attitude limit angle of the aircraft.

In some embodiments, after calculating the flight attitude limitation angle of the aircraft in the current flight mode, the control device can generate the notification message according to the current attitude angle of the gimbal and the flight attitude limit angle of the aircraft. The notification message can be used to notify the user to view the angle data of the gimbal and the aircraft during flight, such that the user can determine whether the control method is valid according to the angle data. The control method being valid refers to the image captured by the photographing apparatus at the gimbal not including the vehicle body of the aircraft through using the control method.

Therefore, the control device can determine the flight attitude limit angle of the aircraft during flight by obtaining the first attitude limit angle of the aircraft, the tilt angle of the gimbal, the second attitude limit angle, and the preset attitude limit angle range. Under the constrain of the flight attitude limit angle, controlling the maximum tilt angle of the aircraft not to exceed the flight attitude limit angle can be realized. The control device can detect the current attitude angle of the gimbal in real time, and if the change of the current attitude angle of the gimbal is detected, the implementation of obtaining the first attitude limit angle of the aircraft can be triggered, and the flight attitude limit angle of the aircraft can be recalculated, thereby dynamically solving the problem of the appearance of the vehicle body of the aircraft in the image captured by the photographing apparatus on the gimbal.

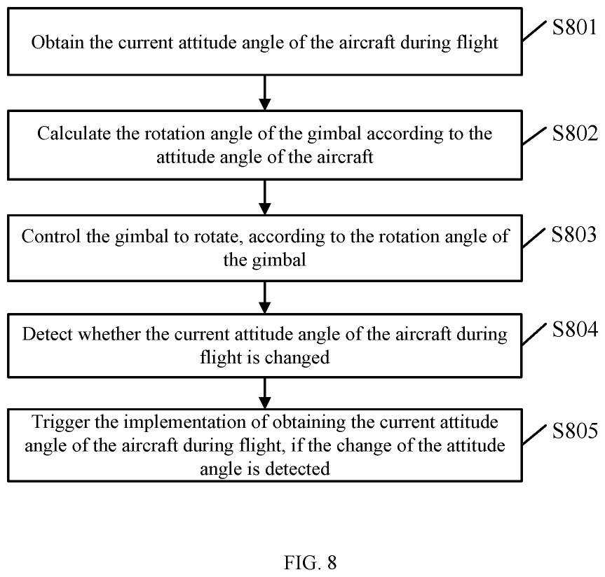

FIG. 8 is a schematic flowchart of the control method consistent with the disclosure. The control method can be implemented by the control device. As shown in FIG. 8, at S801, the current attitude angle of the aircraft during flight is obtained.

In some embodiments, the control device can obtain the current attitude angle of the aircraft during flight. The current flight attitude angle of the aircraft can be the current tilt angle of the aircraft during flight.

At S802, the rotation angle of the gimbal is calculated according to the attitude angle of the aircraft.

In some embodiments, the control device can calculate the rotation angle of the gimbal according to the attitude angle of the aircraft. For example, after obtaining the current attitude angle of the aircraft during flight, the control device can calculate the rotation angle of the gimbal according to a preset rule or the preset formula. The rotation angle can ensure that after the gimbal is rotated for the rotation angle, the image captured by the photographing apparatus arranged at the gimbal does not include the vehicle body of the aircraft.

At S803, according to the rotation angle of the gimbal, the gimbal is controlled to rotate.

In some embodiments, the control device can control the gimbal to rotate according to the rotation angle of the gimbal. For example, after calculating the rotation angle of the gimbal according to the preset rule or the preset formula, the control device can control the rotation of the gimbal according to the rotation angle, such that the image captured by the photographing apparatus arranged at the gimbal does not include the vehicle body of the aircraft.

At S804, whether the current attitude angle of the aircraft during flight is changed is detected.

In some embodiments, the control device can detect in real time whether the current attitude angle of the aircraft during flight is changed.

At S805, If the change of the attitude angle is detected, the implementation of obtaining the current attitude angle of the aircraft during flight is triggered.

In some embodiments, the control device can detect whether the current attitude angle of the aircraft during flight is changed. If the change of the attitude angle is detected, the implementation of the process at S801 can be triggered to obtain the current attitude angle of the aircraft during flight.

Therefore, the control device can obtain the current attitude angle of the aircraft during flight, and calculate the rotation angle of the gimbal according to the attitude angle of the aircraft. As such, the control device can control the rotation of the gimbal according to the rotation angle of the gimbal, such that after the gimbal rotates according to the rotation angle, the image captured by the photographing apparatus arranged at the gimbal does not include the vehicle body of the aircraft.

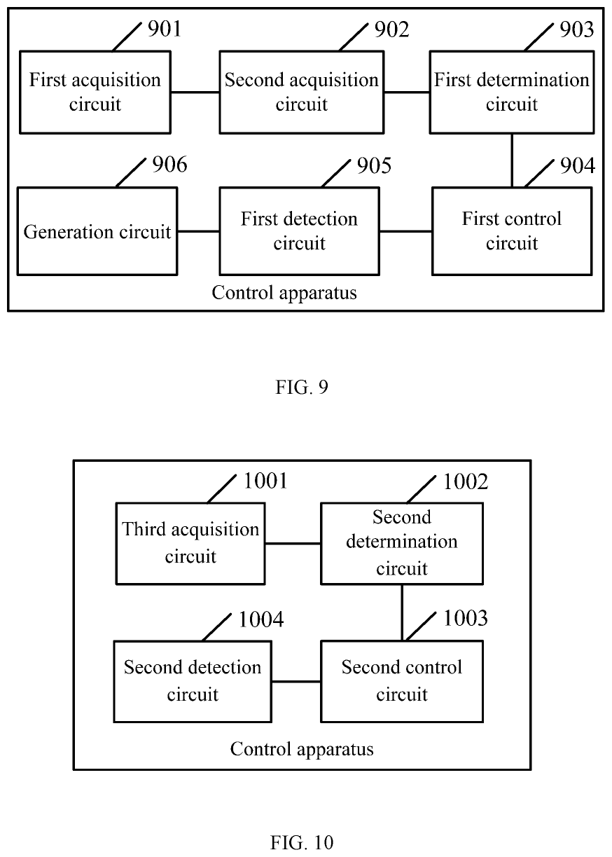

FIG. 9 is a schematic structural diagram of a control apparatus consistent with the disclosure. The control device can include the control apparatus. As shown in FIG. 9, the control apparatus includes a first acquisition circuit 901, a second acquisition circuit 902, and a first determination circuit 903.

The first acquisition circuit 901 can be configured to obtain the first attitude limit angle of the aircraft. The second acquisition circuit 902 can be configured to obtain the current attitude angle of the gimbal mounted at the aircraft. The first determination circuit 903 can be configured to determine the flight attitude limit angle of the aircraft, according to the first attitude limit angle of the aircraft and the current attitude angle of the gimbal. The flight attitude limit angle can be used to constrain the tilt angle of the aircraft relative to the horizontal plane during flight. Under the constrain of the flight attitude limitation angle, the vehicle body of the aircraft would not appear in the image captured by the photographing apparatus arranged at the gimbal.

In some embodiments, the first determination circuit 903 can be configured to determine the second attitude limit angle of the aircraft, and obtain the tilt angle of the gimbal according to the current attitude angle of the gimbal. The tilt angle of the gimbal refers to the angle between the coordinate system of the gimbal and the coordinate system of the vehicle body of the aircraft. The first determination circuit 903 can be further configured to determine the flight attitude limit angle of the aircraft using the preset formula, according to the first attitude limit angle, the tilt angle of the gimbal, the second attitude limit angle, and the preset attitude limit angle range.

In some embodiments, the preset attitude limit angle range can include the first preset attitude limit angle of the gimbal corresponding to the gimbal rotating toward the aircraft, and the second preset attitude limit angle of the aircraft corresponding to the gimbal rotating away from the aircraft.

In some embodiments, the first determination circuit 903 can be further configured to obtain the preset compensation angle and the preset initial attitude angle of the aircraft. The initial attitude angle refers to the tilt angle of the aircraft at which the image captured by the photographing apparatus mounted on the gimbal does not include the vehicle body of the aircraft. The first determination circuit 903 can be further configured to determine the second attitude limit angle of the aircraft, according to the preset initial attitude angle and the preset compensation angle.

In some embodiments, the control apparatus further includes a first control circuit 904. The first control circuit 904 can be configured, with the gimbal maintaining the current attitude angle, to control the maximum tilt angle of the aircraft not to exceed the flight attitude limit angle.

In some embodiments, the control apparatus further includes a first detection circuit 905. The first detection circuit 905 can be configured to detect whether the current attitude angle of the gimbal is changed, and trigger the implementation of obtaining the first attitude limit angle of the aircraft, if the current attitude angle of the gimbal is changed.

In some embodiments, the control apparatus further includes a generation circuit 906. The generation circuit 906 can be configured to generate the notification message according to the current attitude angle of the gimbal and the flight attitude limit angle of the aircraft. The notification message can be used to notify the user to view the angle data of the gimbal and the aircraft.

The implementation of each circuit of the control apparatus is similar to the corresponding process of the control method shown in FIGS. 6 and 7, and detailed descriptions are omitted herein.

Therefore, through obtaining the first attitude limit angle of the aircraft and the current attitude angle of the gimbal, the control apparatus can determine the flight attitude limit angle of the aircraft during flight. The maximum tilt angle of the aircraft can be controlled not to exceed the flight attitude limit angle, under the constrain of the flight attitude limit angle. As such, the problem of the appearance of the vehicle body of the aircraft in the image captured by the photographing apparatus at the gimbal can be solved.

FIG. 10 is a schematic structural diagram of the control apparatus consistent with the disclosure. The control device can include the control apparatus. As shown in FIG. 10, the control apparatus includes a third acquisition circuit 1001, a second determination circuit 1002, and a second control circuit 1003.

The third acquisition circuit 1001 can be configured to obtain the current attitude angle of the aircraft during flight. The second determination circuit 1002 can be configured to calculate the rotation angle of the gimbal according to the attitude angle of the aircraft. The second control circuit can be configured to control the gimbal to rotate according to the rotation angle of the gimbal. The rotation angle can ensure that after the gimbal is rotated for the rotation angle, the image captured by the photographing apparatus arranged at the gimbal does not include the vehicle body of the aircraft.

In some embodiments, the control apparatus further includes a second detection circuit 1004. The second detection circuit 1004 can be configured to detect whether the current attitude angle of the aircraft during flight is changed, and trigger the implementation of obtaining the current attitude angle of the aircraft during flight, if the change of the attitude angle is detected.

The implementation of each circuit of the control apparatus is similar to the corresponding process of the control method shown in FIG. 8, and detailed descriptions are omitted herein.

Therefore, the control device can obtain the current attitude angle of the aircraft during flight, and calculate the rotation angle of the gimbal according to the attitude angle of the aircraft. As such, the control device can control the rotation of the gimbal according to the rotation angle of the gimbal, such that after the gimbal rotates according to the rotation angle, the image captured by the photographing apparatus arranged at the gimbal does not include the vehicle body of the aircraft.

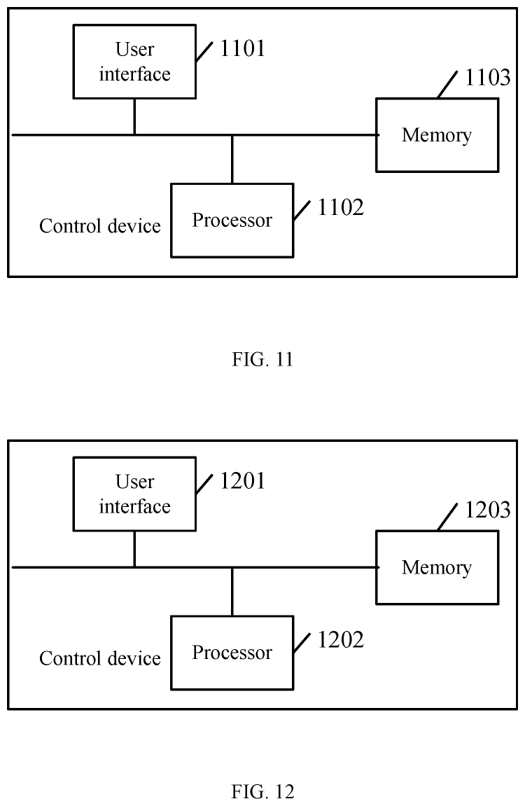

FIG. 11 is a schematic structural diagram of the control device consistent with the disclosure. As shown in FIG. 11, the control device includes a user interface 1101, a processor 1102, and a memory 1103. The user interface 1101 can be configured to process interaction data generated by the user, and can include components, such as a touch screen or the like.

The memory 1103 can include a volatile memory, a non-volatile memory, or a combination of the volatile memory and the non-volatile memory. The processor 1102 can include a central processing unit (CPU). The processor 1102 can further include a hardware chip. The hardware chip can include an application-specific integrated circuit (ASIC), a programmable logic device (PLD), or a combination thereof. The PLD can include a complex programmable logic device (CPLD), a field-programmable gate array (FPGA), or any combination thereof.

In some embodiments, the memory 1103 can be configured to store program instructions. The processor 1102 can be configured to recall the program instructions stored in the memory 1103 to implement the control method shown FIGS. 6 and 7.

In some embodiments, the processor 1102 can be configured to obtain the first attitude limit angle of the aircraft, obtain the current attitude angle of the gimbal mounted at the aircraft, and determine the flight attitude limit angle of the aircraft according to the first attitude limit angle of the aircraft and the current attitude angle of the gimbal. The flight attitude limit angle can be used to constrain the tilt angle of the aircraft relative to the horizontal plane during flight. Under the constrain of the flight attitude limitation angle, the vehicle body of the aircraft would not appear in the image captured by the photographing apparatus arranged at the gimbal.

In some embodiments, the processor 1102 can be further configured to determine the second attitude limit angle of the aircraft, and obtain the tilt angle of the gimbal according to the current attitude angle of the gimbal. The tilt angle of the gimbal refers to the angle between the coordinate system of the gimbal and the coordinate system of the vehicle body of the aircraft.

The processor 1102 can be further configured to determine the flight attitude limit angle of the aircraft using the preset formula according to the first attitude limit angle, the tilt angle of the gimbal, the second attitude limit angle, and the preset attitude limit angle range. In some embodiments, the preset attitude limit angle range can include the first preset attitude limit angle of the gimbal corresponding to the gimbal rotating toward the aircraft, and the second preset attitude limit angle of the aircraft corresponding to the gimbal rotating away from the aircraft.

In some embodiments, the processor 1102 can be further configured to obtain the preset compensation angle and the preset initial attitude angle of the aircraft. The initial attitude angle refers to the tilt angle of the aircraft at which the image captured by the photographing apparatus mounted on the gimbal does not include the vehicle body of the aircraft. The processor 1102 can be further configured to determine the second attitude limit angle of the aircraft according to the preset initial attitude angle and the preset compensation angle.

In some embodiments, the processor 1102 can be further configured, with the gimbal maintaining the current attitude angle, to control the maximum tilt angle of the aircraft not to exceed the flight attitude limit angle.

In some embodiments, the processor 1102 can be further configured to detect whether the current attitude angle of the gimbal is changed, and trigger the implementation of obtaining the first attitude limit angle of the aircraft, if the current attitude angle of the gimbal is changed.

In some embodiments, the processor 1102 can be further configured to generate the notification message according to the current attitude angle of the gimbal and the flight attitude limit angle of the aircraft. The notification message can be used to notify the user to view the angle data of the gimbal and the aircraft.

The implementation of the processor 1102 is similar to the corresponding process of the control method shown in FIGS. 6 and 7, and detailed descriptions are omitted herein.

Therefore, the control device can determine the flight attitude limit angle of the aircraft during flight by obtaining the first attitude limit angle of the aircraft, the tilt angle of the gimbal, the second attitude limit angle, and the preset attitude limit angle range. Under the constrain of the flight attitude limit angle, controlling the maximum tilt angle of the aircraft not to exceed the flight attitude limit angle can be realized. The control device can detect the current attitude angle of the gimbal in real time, and if the change of the current attitude angle of the gimbal is detected, the implementation of obtaining the first attitude limit angle of the aircraft can be triggered, and the flight attitude limit angle of the aircraft can be recalculated, thereby dynamically solving the problem of the appearance of the vehicle body of the aircraft in the image captured by the photographing apparatus on the gimbal.

FIG. 12 is a schematic structural diagram of the control device consistent with the disclosure. As shown in FIG. 12, the control device includes a user interface 1201, a processor 1202, and a memory 1203. The user interface 1201 can be configured to process interaction data generated by the user, and can include components, such as a touch screen or the like.

The memory 1203 can include a volatile memory, a non-volatile memory, or a combination of the volatile memory and the non-volatile memory. The processor 1202 can include a central processing unit (CPU). The processor 1202 can further include a hardware chip. The hardware chip can include an application-specific integrated circuit (ASIC), a programmable logic device (PLD), or a combination thereof. The PLD can include a complex programmable logic device (CPLD), a field-programmable gate array (FPGA), or any combination thereof.

In some embodiments, the memory 1203 can be configured to store program instructions. The processor 1202 can be configured to recall the program instructions stored in the memory 1203 to implement the control method shown FIG. 8.

In some embodiments, the processor 1202 can be configured to obtain the current attitude angle of the aircraft during flight, calculate the rotation angle of the gimbal according to the attitude angle of the aircraft, and control the gimbal to rotate according to the rotation angle of the gimbal. The rotation angle can ensure that after the gimbal is rotated for the rotation angle, the image captured by the photographing apparatus arranged at the gimbal does not include the vehicle body of the aircraft.

In some embodiments, the processor 1202 can be further configured to detect whether the current attitude angle of the aircraft during flight is changed, and trigger the implementation of obtaining the current attitude angle of the aircraft during flight, if the change of the attitude angle is detected.

The implementation of the processor is similar to the corresponding process of the control method shown in FIG. 8, and detailed descriptions are omitted herein.

Therefore, the control device can obtain the current attitude angle of the aircraft during flight, and calculate the rotation angle of the gimbal according to the attitude angle of the aircraft. As such, the control device can control the rotation of the gimbal according to the rotation angle of the gimbal, such that after the gimbal rotates according to the rotation angle, the image captured by the photographing apparatus arranged at the gimbal does not include the vehicle body of the aircraft.

An UAV consistent with the disclosure can include a vehicle body, a power system arranged at the vehicle body, and a flight controller. The power system can be configured to provide a flight power to the UAV. The flight controller can be configured to obtain the first attitude limit angle of the aircraft, obtain the current attitude angle of the gimbal mounted at the aircraft, and determine the flight attitude limit angle of the aircraft according to the first attitude limit angle of the aircraft and the current attitude angle of the gimbal. The flight attitude limit angle can be used to constrain the tilt angle of the aircraft relative to the horizontal plane during flight. Under the constrain of the flight attitude limitation angle, the vehicle body of the aircraft would not appear in the image captured by the photographing apparatus arranged at the gimbal.

In some embodiments, the flight controller can be further configured to determine the second attitude limit angle of the aircraft and obtain the tilt angle of the gimbal according to the current attitude angle of the gimbal. The tilt angle of the gimbal refers to the angle between the coordinate system of the gimbal and the coordinate system of the vehicle body of the aircraft.

The flight controller can be further configured to determine the flight attitude limit angle of the aircraft using the preset formula according to the first attitude limit angle, the tilt angle of the gimbal, the second attitude limit angle, and the preset attitude limit angle range. In some embodiments, the preset attitude limit angle range can include the first preset attitude limit angle of the gimbal corresponding to the gimbal rotating toward the aircraft, and the second preset attitude limit angle of the aircraft corresponding to the gimbal rotating away from the aircraft.

In some embodiments, the flight controller can be further configured to obtain the preset compensation angle and the preset initial attitude angle of the aircraft. The initial attitude angle refers to the tilt angle of the aircraft at which the image captured by the photographing apparatus mounted at the gimbal does not include the vehicle body of the aircraft. The flight controller can be further configured to determine the second attitude limit angle of the aircraft, according to the preset initial attitude angle and the preset compensation angle.

In some embodiments, the flight controller can be further configured, with the gimbal maintaining the current attitude angle, to control the maximum tilt angle of the aircraft not to exceed the flight attitude limit angle.

In some embodiments, the flight controller can be further configured to detect whether the current attitude angle of the gimbal is changed, and trigger the implementation of obtaining the first attitude limit angle of the aircraft, if the current attitude angle of the gimbal is changed.

In some embodiments, the flight controller can be further configured to generate the notification message, according to the current attitude angle of the gimbal and the flight attitude limit angle of the aircraft. The notification message can be used to notify the user to view the angle data of the gimbal and the aircraft.

The implementation of the flight controller of the UAV is similar to the implementation of the control device shown in FIG. 11, and detailed descriptions are omitted herein.

The UAV can be any type of aircraft, such as a quadrotor USV, a six-rotor UAV, or a multi-rotor UAV. The power system can include a motor, an electronic speed control (ESC), a propeller, and/or the like. The motor can be configured to drive the propeller of the UAV, and the ESC can be configured to control a speed of the motor of the UAV.

Another UAV consistent with the disclosure includes the vehicle body, the power system arranged at the vehicle body, and the flight controller. The power system can be configured to provide the flight power to the UAV. The flight controller can be configured to obtain the current attitude angle of the aircraft during flight, calculate the rotation angle of the gimbal according to the attitude angle of the aircraft, and control the gimbal to rotate according to the rotation angle of the gimbal. The rotation angle can ensure that after the gimbal is rotated for the rotation angle, the image captured by the photographing apparatus arranged at the gimbal does not include the vehicle body of the aircraft.

In some embodiments, the flight controller can be further configured to detect whether the current attitude angle of the aircraft during flight is changed, and trigger the implementation of obtaining the current attitude angle of the aircraft during flight, if the change of the attitude angle is detected.

The implementation of the flight controller of the UAV is similar to the implementation of the control device shown in FIG. 12, and detailed descriptions are omitted herein.

The UAV can be any type of aircraft, such as the quadrotor USV, the six-rotor UAV, or the multi-rotor UAV. The power system can include the motor, the ESC, the propeller, and/or the like. The motor can be configured to drive the propeller of the UAV, and the ESC can be configured to control the speed of the motor of the UAV.

A computer readable storage medium consistent with the disclosure can be configured to store a computer program. When the computer program is executed by the processor, the control method shown in FIGS. 6 and 7, or FIG. 8 can be implemented, or the control device shown in FIG. 9 or FIG. 10 can also be realized, and detailed descriptions are omitted herein.

The computer readable storage medium can include an internal storage unit of the control device described above, such as a hard disk or a memory of the control device. The computer readable storage medium can also include an external storage device of the control device, such as a plug-in hard disk arranged at the control device, a smart memory card (SMC), a Secure Digital (SD) card, a Flash Card, or the like. In some embodiments, the computer readable storage medium may also include both the internal storage unit of the control device and the external storage device. The computer readable storage medium can be configured to store the computer program and other programs and data required by the control device. The computer readable storage medium can also be configured to temporarily store data that has been output or is about to be output.

It will be appreciated that the described embodiments are merely exemplary and not to limit the scope of the disclosure. Any equivalent variations based on the following claims of the disclosure are falling within the scope of the disclosure.

What is claimed is:

1. A control method comprising:
obtaining an attitude limit angle of an aircraft;
obtaining a current attitude angle of a gimbal mounted at the aircraft; and
determining a flight attitude limit angle of the aircraft according to the attitude limit angle of the aircraft and the current attitude angle of the gimbal, the flight attitude limit angle being configured to constrain a tilt angle of the aircraft relative to a horizontal plane during flight, such that a vehicle body of the aircraft does not appear in an image captured by a photographing apparatus arranged at the gimbal.

2. The method of claim 1, wherein:
the attitude limit angle is a first attitude limit angle; and
determining the flight attitude limit angle of the aircraft includes:
obtaining a second attitude limit angle of the aircraft;
obtaining a tilt angle of the gimbal according to the current attitude angle of the gimbal, the tilt angle of the gimbal being an angle between a coordinate system of the gimbal and a coordinate system of the vehicle body of the aircraft; and
determining the flight attitude limit angle of the aircraft using a preset formula according to the first attitude limit angle, the tilt angle of the gimbal, the second attitude limit angle, and a preset attitude limit angle range.

3. The method of claim 2, wherein the preset attitude limit angle range includes:
a first preset attitude limit angle of the gimbal corresponding to the gimbal rotating toward the aircraft; and
a second preset attitude limit angle of the aircraft corresponding to the gimbal rotating away from the aircraft.

4. The method of claim 2, wherein obtaining the second attitude limit angle of the aircraft includes:
obtaining a preset compensation angle;
obtaining a preset initial attitude angle of the aircraft, the preset initial attitude angle being the tilt angle of the aircraft at which the image captured by the photographing apparatus mounted at the gimbal does not include the vehicle body of the aircraft; and
determining the second attitude limit angle of the aircraft, according to the preset initial attitude angle and the preset compensation angle.

5. The method of claim 1, further comprising:
controlling a maximum tilt angle of the aircraft not to exceed the flight attitude limit angle, with the gimbal maintaining the current attitude angle.

6. The method of claim 1, further comprising:
detecting whether the current attitude angle of the gimbal is changed; and
triggering an implementation of obtaining the attitude limit angle of the aircraft in response to the current attitude angle of the gimbal being changed.

7. The method of claim 1, further comprising:
generating a notification message according to the current attitude angle of the gimbal and the flight attitude limit angle of the aircraft.

8. A control method comprising:
obtaining a current attitude angle of an aircraft during flight;
calculating a rotation angle of a gimbal mounted at the aircraft according to the current attitude angle of the aircraft; and
controlling the gimbal to rotate according to the rotation angle of the gimbal, the rotation angle being an angle that, after the gimbal is rotated for the rotation angle, an image captured by a photographing apparatus arranged at the gimbal does not include a vehicle body of the aircraft.

9. The method of claim 8, further comprising:
detecting whether the current attitude angle of the aircraft during flight is changed; and
triggering an implementation of obtaining the current attitude angle of the aircraft during flight in response to detecting that the current attitude angle is changed.

10. A control device comprising:
a memory storing program instructions; and
a processor configured to execute the program instructions to:
obtain an attitude limit angle of an aircraft;
obtain a current attitude angle of a gimbal mounted at the aircraft; and
determine a flight attitude limit angle of the aircraft according to the attitude limit angle of the aircraft and the current attitude angle of the gimbal, the flight attitude limit angle being configured to constrain a tilt angle of the aircraft relative to a horizontal plane during flight, such that a vehicle body of the aircraft does not appear in an image captured by a photographing apparatus arranged at the gimbal.

11. The device of claim 10, wherein:
the attitude limit angle is a first attitude limit angle; and
the processor is further configured to execute the program instructions to:
obtain a second attitude limit angle of the aircraft;
obtain a tilt angle of the gimbal according to the current attitude angle of the gimbal, the tilt angle of the gimbal being an angle between a coordinate system of the gimbal and a coordinate system of the vehicle body of the aircraft; and
determine the flight attitude limit angle of the aircraft using a preset formula, according to the first attitude limit angle, the tilt angle of the gimbal, the second attitude limit angle, and a preset attitude limit angle range.

12. The device of claim 11, wherein the preset attitude limit angle range includes:
a first preset attitude limit angle of the gimbal corresponding to the gimbal rotating toward the aircraft; and
a second preset attitude limit angle of the aircraft corresponding to the gimbal rotating away from the aircraft.

13. The device of claim 11, wherein the processor is further configured to execute the program instructions to:
obtain a preset compensation angle;
obtain a preset initial attitude angle of the aircraft, the preset initial attitude angle being the tilt angle of the aircraft at which the image captured by the photographing apparatus mounted at the gimbal does not include the vehicle body of the aircraft; and
determine the second attitude limit angle of the aircraft, according to the preset initial attitude angle and the preset compensation angle.

14. The device of claim 10, wherein the processor is further configured to execute the program instructions to:
control a maximum tilt angle of the aircraft not to exceed the flight attitude limit angle, with the gimbal maintaining the current attitude angle.

15. The device of claim 10, wherein the processor is further configured to execute the program instructions to:
detect whether the current attitude angle of the gimbal is changed; and
trigger an implementation of obtaining the attitude limit angle of the aircraft in response to the current attitude angle of the gimbal being changed.

16. The device of claim 10, wherein the processor is further configured to execute the program instructions to:
generate a notification message according to the current attitude angle of the gimbal and the flight attitude limit angle of the aircraft.

17. An unmanned aerial vehicle (UAV) comprising:
a vehicle body;
a power system arranged at the vehicle body and configured to provide a flight power to the UAV; and
a flight controller configured to:
obtain an attitude limit angle of an aircraft;
obtain a current attitude angle of a gimbal mounted at the aircraft; and
determine a flight attitude limit angle of the aircraft according to the attitude limit angle of the aircraft and the current attitude angle of the gimbal, the flight attitude limit angle being configured to constrain a tilt angle of the aircraft relative to a horizontal plane during flight, such that a vehicle body of the aircraft does not appear in an image captured by a photographing apparatus arranged at the gimbal.

18. The UAV of claim 17, wherein:
the attitude limit angle is a first attitude limit angle; and
the flight controller is further configured to:
obtain a second attitude limit angle of the aircraft;
obtain a tilt angle of the gimbal according to the current attitude angle of the gimbal, the tilt angle of the gimbal being an angle between a coordinate system of the gimbal and a coordinate system of the vehicle body of the aircraft; and
determine the flight attitude limit angle of the aircraft using a preset formula, according to the first attitude limit angle, the tilt angle of the gimbal, the second attitude limit angle, and a preset attitude limit angle range.

19. The UAV of claim 18, wherein the preset attitude limit angle range includes:
a first preset attitude limit angle of the gimbal corresponding to the gimbal rotating toward the aircraft; and
a second preset attitude limit angle of the aircraft corresponding to the gimbal rotating away from the aircraft.

20. The UAV of claim 18, wherein the flight controller is further configured to:
obtain a preset compensation angle;
obtain a preset initial attitude angle of the aircraft, the preset initial attitude angle being the tilt angle of the aircraft at which the image captured by the photographing apparatus mounted at the gimbal does not include the vehicle body of the aircraft; and
determine the second attitude limit angle of the aircraft according to the preset initial attitude angle and the preset compensation angle.

21. The UAV of claim 17, wherein the flight controller is further configured to:
control a maximum tilt angle of the aircraft not to exceed the flight attitude limit angle, with the gimbal maintaining the current attitude angle.

22. The UAV of claim 17, wherein the flight controller is further configured to:
detect whether the current attitude angle of the gimbal is changed; and
trigger an implementation of obtaining the attitude limit angle of the aircraft in response to the current attitude angle of the gimbal being changed.

23. The UAV of claim 17, wherein the flight controller is further configured to:
generate a notification message according to the current attitude angle of the gimbal and the flight attitude limit angle of the aircraft.
